(19) United States
(12) Patent Application Publication
(10) Pub. No.: US 2004/0073879 A1
(43) Pub. Date: Apr. 15, 2004

(54) Modeling devices in consideration of process fluctuations

(76) Inventors: Ping Chen, San Jose, CA (US); Xisheng Zhang, Sunnyvale, CA (US)

Correspondence Address: MORGAN, LEWIS & BOCKIUS, LLP., 3300 HILLVIEW AVENUE, PALO ALTO, CA, 94304, US

(21) Appl. No.: 10/439,755

(22) Filed: May 15, 2003

Related U.S. Application Data
(60) Provisional application No. 60/381,068, filed on May 15, 2002.

(51) Int. Cl. G06F 17/50

(52) U.S. Cl. 716/8; 716/4; 703/2; 703/14

(57) ABSTRACT

The present invention includes a method for generating typical and corner device models to account for statistical variations in a semiconductor device fabrication process. The typical and corner models can be generated before the semiconductor device fabrication process is fully developed based on a process specification associated with the semiconductor device fabrication process. The typical and corner models can also be generated with better accuracy after the semiconductor device fabrication process is developed and measured data are available for model generation.

This patent claims priority to 35 U.S.C. § 119(e) to U.S. Provisional Patent Application Serial No. 60/381,068, filed May 15, 2002.

The present application relates to computer aided design of electronic circuits, and particularly to a method of generating device models for circuit simulation.

### BACKGROUND OF THE INVENTION

Computer aids for electronic circuit designers are becoming more and more popular. Examples of these computer aids include electronic circuit simulators such as the Simulation Program with Integrated Circuit Emphasis (SPICE) developed at the University of California, Berkeley (UC Berkeley), and various enhanced versions or derivatives of SPICE, such as, SPICE2 or SPICE3, also developed at UC Berkeley, HSPICE, developed by Meta-software and now owned by Avant!, PSPICE, developed by Micro-Sim, and SPECTRE, developed by Cadence. The SPICE and its derivatives or enhanced versions will be referred to hereafter as SPICE circuit simulators.

An electronic circuit may contain circuit elements such as resistors, capacitors, inductors, mutual inductors, transmission lines, diodes, bipolar junction transistors (BJT), junction field effect transistors (JFET), and metal-on-silicon field effect transistors (MOSFET), etc. A SPICE circuit simulator is a program that simulates the performance of electronic circuits. SPICE solves sets of non-linear differential equations in the frequency domain, steady state and time domain and can simulate the behavior of transistor and gate designs. In SPICE, a circuit is handled in a node/element fashion, i.e., the circuit is regarded as a collection of various elements (transistors, resistors, capacitors, etc.) and the elements are connected at nodes. Thus, each element must be modeled in order to simulate the entire circuit. Most SPICE circuit simulators have built in models for modeling semiconductor devices, and are set up so that the user need only specify model parameter values associated with the models.

Whether it is built-in or plug-in, a device model for a SPICE circuit simulator typically includes model equations and a set of model parameters, which are used to mathematically represent device characteristics of a device element under various bias conditions. For example, for a MOSFET device model, in DC and AC analysis, the inputs of the device model are the drain-to-source, gate-to-source, bulk-to-source voltages, and the device temperature, and the outputs are the various terminal currents. Therefore, the model parameters, along with the model equations in the device model, directly affect the final outcome of the terminal currents.

A collection of the model parameter values for modeling a particular device is commonly called a model card for the device. In order to represent actual device performance, the model card is typically tied to the actual fabrication process used to manufacture the device. This tie is represented by the dependence of the model parameter values on the fabrication process used to manufacture the device. In an ideal world, the fabrication process should produce the semiconductor devices exactly as desired, resulting in identical devices from die to die and wafer to wafer. In reality, however, even a well developed, stable and finely controlled fabrication process would result in systematic statistical variations in the devices produced. These variations are likely to affect the device characteristics and circuit behavior, and therefore need to be accounted for in the device models.

### SUMMARY OF THE INVENTION

The present invention includes a method for generating device models to account for the statistical variations in a semiconductor device fabrication process. In one embodiment of the present invention, a plurality of model cards including a typical model card (“typical model”) and one or more corner model cards (“corner models”) are used to model a device. The typical model includes typical values of the model parameters for modeling typical device performance, and the corner models includes corner values, and/or sigma values, of the model parameters for modeling deviations from typical device performance resulted from process fluctuations. The sigma value of a model parameter represents deviation of the corner value of the model parameter from the typical value of the model parameter.

In one aspect of the present invention, based on a process specification associated with the semiconductor device fabrication process, an initial set of typical and corner device models can be generated for a device before the semiconductor device fabrication process for fabricating device is fully developed. In one embodiment of the present invention, to generate the initial typical model, the typical values of the model parameters are determined by first obtaining values of the model parameters from a device model card associated with a previous device fabrication process and then retargeting the values of a set of process dependent model parameters among the model parameters. The process dependent model parameters are retargeted by fitting values of a set of physical quantities calculated using the model parameters to specified values of the physical quantities in the process specification.

In one embodiment of the present invention, to generate an initial corner model, the corner values of the model parameters are determined by first determining sigma values of a set of basic process parameters, and then by using the sigma values of the set of basic process parameters to calculate corner values of a set of process dependent model parameters.

In another aspect of the present invention, typical and corner models are generated after the semiconductor device fabrication process is developed and measured data are available for model generation. The measured data are preferably obtained from fabricated devices on a plurality of semiconductor dies taken from a plurality of semiconductor wafers, which have come from different wafer lots. In one embodiment of the present invention, the typical values of the model parameters are determined by first finding a typical die from the plurality of dies and then retargeting the values of a set of process dependent model parameters extracted based on data measured on the typical die. The set of process dependent model parameters are retargeted by fitting values of a set of physical quantities calculated using the set of process dependent model parameters to specified values of the set of physical quantities in the process specification.

In one embodiment of the present invention, the corner models are generated based on measured data. The corner values of the model parameters are determined by first determining sigma values of a set of basic process parameters, and then by calculating corner values of process dependent model parameters using the sigma values of the set of basic process parameters. To determine the sigma values of the set of basic process parameters, values of a set of physical quantities are calculated based on measured data from the plurality of dies. Distributions of the values of the set of physical quantities across the plurality of dies are then determined, which distributions are used to determine corner values of the set of physical quantities. The sigma values of the set of basic process parameters are determined by fitting the corner values of the set of physical quantities calculated from the sigma values of the set of basic process parameters to the corner values of the set of physical quantities determined based on the distributions.

### BRIEF DESCRIPTION OF THE DRAWINGS

Additional objects and features of the invention will be more readily apparent from the following detailed description and appended claims when taken in conjunction with the drawings, in which:

FIG. 1A is a block diagram of an exemplary computer system that can be used to carry out the method for modeling devices according to one embodiment of the present invention;

FIG. 1B is a flowchart illustrating a method for modeling devices in consideration of fluctuations in device fabrication processes according to one embodiment of the present invention;

FIG. 2A is a flowchart illustrating a method of generating an initial typical model for a semiconductor device based on a process specification according to one embodiment of the present invention;

FIG. 2B is a flowchart illustrating a method of retargeting a set of model parameters according to one embodiment of the present invention;

FIG. 3A is a flowchart illustrating a method of generating initial corner models for a semiconductor device based on a process specification according to one embodiment of the present invention;

FIG. 3B is a flowchart illustrating a method for obtaining sigma values for a set of basic process parameters according to one embodiment of the present invention;

FIG. 4A is a flowchart illustrating a method of generating a typical model for a semiconductor device based on measured data from actual devices according to one embodiment of the present invention;

FIG. 4B is a flowchart illustrating a method of selecting a typical die from a plurality of dies according to one embodiment of the present invention.

FIG. 4C is a diagram illustrating a set of measured data from actual devices according to one embodiment of the present invention;

FIG. 5A is a flowchart illustrating a method of generating corner models for a semiconductor device based on measured data according to one embodiment of the present invention;

FIG. 5B is a flowchart illustrating a method of generating corner models for a semiconductor device based on measured data from actual devices according to one embodiment of the present invention; and

FIG. 5C is a graph illustrating the statistical distribution of two related physical quantities caused by process fluctuation.

### DETAILED DESCRIPTION OF THE INVENTION

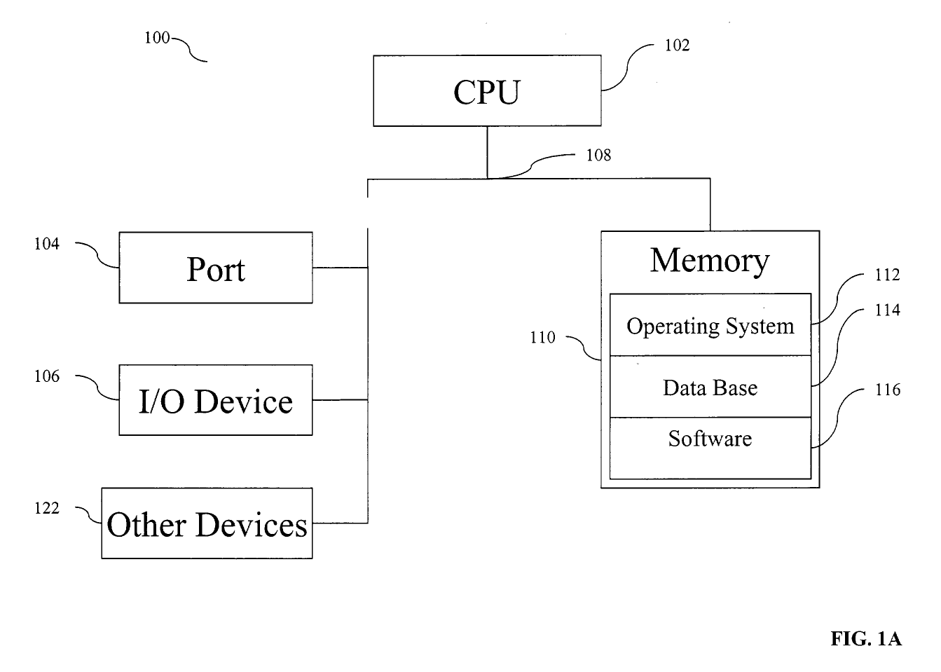

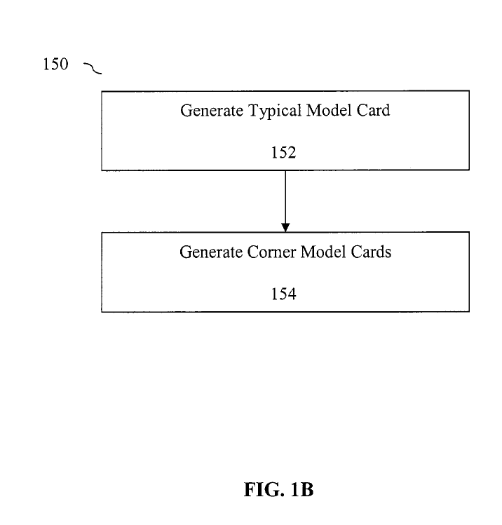

The method for modeling a device in consideration of fluctuations in the device fabrication process can be performed in a computer system, such as system 100 as illustrated in FIG. 1A according to one embodiment of the present invention. Referring to FIG. 1A, system 100 comprises a central processing unit (CPU) 102 and a disk memory 110 coupled to the CPU 102 through a bus 108. The system 100 further comprises a set of input/output (I/O) devices 106, such as a keypad, a mouse, and a display device, also coupled to the CPU 102 through the bus 108. The system 100 may further include an input port 104 for receiving data from a measurement device (not shown), as explained in more detail below. The system 100 may also include other devices 122. An example of system 100 is a Pentium 233 PC/Compatible computer having RAM larger than 64 MB and a hard disk larger than 1 GB.

The CPU 102 includes a random access memory device (RAM), and the disk memory 110 has computer readable memory spaces such as database 114 that stores data, memory space 112 that stores operating system 112 such as Windows 95/98/NT4.0/2000, which has instructions for communicating, processing, accessing, storing and searching data, and memory space 116 that stores program instructions (software) for carrying out the method for modeling a device in consideration of fluctuations in the device fabrication process according to one embodiment of the present invention.

Referring to FIG. 1B, in one embodiment of the present invention, the method 150 for modeling a device in consideration of fluctuations in the device fabrication process includes step 152 in which a typical model is generated and step 154 in which one or more corner models are generated. The typical model predicts typical circuit performance of the semiconductor device, while the corner models represent deviations from typical situations. The typical model and the corner models can be used by a circuit designer in a circuit simulator, such as SPICE, to simulate the performance of an integrated circuit (IC). Typically, the circuit designer uses the typical model to design circuits and the corner models to do the final checking to insure that the circuit will perform properly even with statistical variations of the performance characteristics of the semiconductor devices in the circuit.

Fabrication process development and circuit design for a new IC technology usually start at about the same time. The fabrication process is developed according to a process specification, which can be the result of discussions among process engineers, modeling engineers and design engineers. The process specification may include typical values and standard deviation values for specific electrical/physical quantities, such as threshold voltage (Vth), drain saturation current (Idsat), and gate oxide thickness (Tox), etc., of various MOSFET devices. Before the fabrication process is fully developed, initial typical model and corner models for a semiconductor device may be generated based on the process specification with some reference to the device models associated with a previous IC fabrication technology. Circuit designers may use these initial models to come up with an initial design of the IC. This way, circuit design may proceed concurrently with fabrication process development.

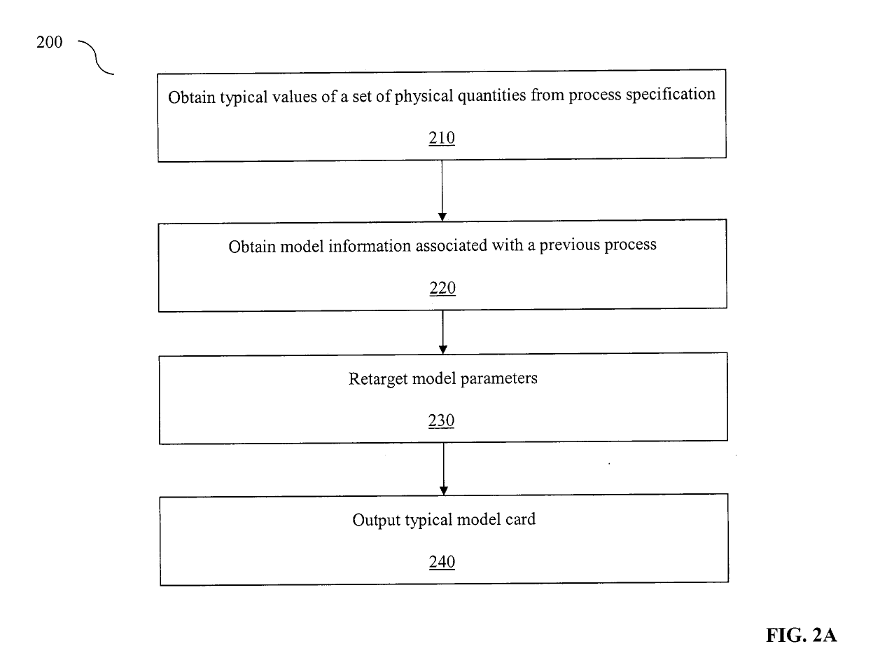

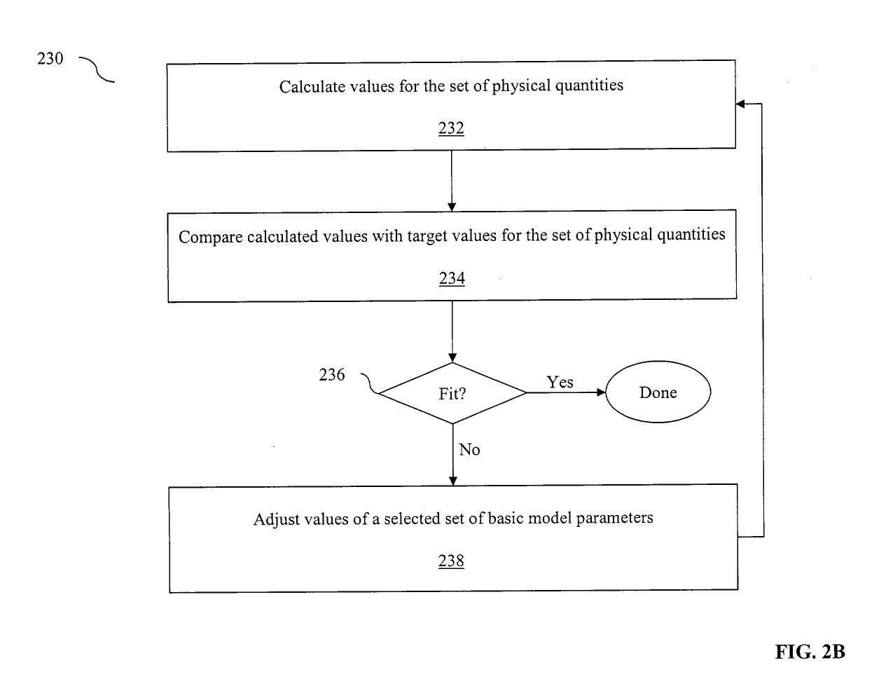

Referring now to FIG. 2A, according to one embodiment of the present invention, a process 200 for generating the initial typical model for a semiconductor device includes step 210 in which typical values for a set of physical quantities (targets) associated with the semiconductor device are obtained from the process specification. The selection of the targets depends on the type of semiconductor device being modeled and the type of model used to model the device. For example, when the BSIM3 model is used to model MOSFET devices, the targets typically include the threshold voltage (Vth), the drain saturation current (Idsat), the gate oxide thickness (Tox), etc., for the MOSFET devices. A latest version of the model equations and a list of the model parameter names for the BSIM3 model can be found on the BSIM website http://www-device.EECS.Berkeley.EDU/bsim3.

Process 200 further includes step 220 in which model information associated with a previous IC technology is obtained. The previous IC technology includes a previous IC fabrication process for fabricating an IC having devices similar to the device being modeled. The model information associated with the previous IC technology includes the values of model parameters in a typical model card for modeling a similar device fabricated using the previous IC technology.

Process 200 further includes step 230 in which a selected set of model parameters are retargeted. The selected set of model parameters may be different for different type of semiconductor device being modeled or different model used to model the device. For example, when the BSIM3 model is used to model MOSFET devices, the selected set of model parameters includes Vth0, U0, Tox, Rds, Vsat, etc. Retargeting in step 230 includes adjusting the values of the selected set of model parameters to fit the process specification, and can be done using a conventional optimization method or a proprietary optimizer such as the one in BSIMPro+™, which is a model parameter extraction tool commercially available from Cadence Design Systems in San Jose, Calif. In one embodiment of the present invention, as shown in FIG. 2B, retargeting in step 230 includes substep 232 in which values for the targets are calculated based on the values of the selected set of model parameters. The calculation in substep 232 utilizes relevant model equations or device physics knowledge known to those skilled in the art. Values of other model parameters in the typical model card associated with the previous IC technology may also be used in the calculation. Retargeting in step 232 further includes substep 234 in which the calculated values of the targets are compared with the typical values of the targets obtained from the process specification, using, for example, a Newton-Ralphson optimizer. If the differences between the calculated and specified values of the targets are determined in substep 236 to be beyond preset acceptable limits, the values of the selected set of model parameters are adjusted accordingly in substep 238 by the Newton-Ralphson optimizer, and the targets are recalculated based on the adjusted values for the set of selected model parameters. This process repeats until the difference between the calculated values and typical values of the targets are within the acceptable limits. The final values of the retargeted model parameters, together with the values of other model parameters in the typical model card associated with the previous IC technology are output in step 240 in process 200 as the initial typical model card for the new IC technology.

With the initial typical model available, an initial set of corner models may also be generated based on process specification. Variations in fabrication processes usually cause variation in the performance characteristics of the devices in the circuit. Some devices will cause the circuit to have faster response to input signals, while some will cause the circuit to have slower response to input signals. Variations of a physical quantity associated with a device can be reflected by one or more sigma values associated with each process dependent model parameter in the device model. In one embodiment of the present invention, for the design of a CMOS circuit, the initial set of corner models typically comprises four different types of corner models, each corresponding to one of the following corner situations:

1) the CMOS circuit with fastest N-type devices and fastest P-type devices (FNFP);

2) the CMOS circuit with fastest N-type devices and slowest P-type devices (FNSP);

3) the CMOS circuit with slowest N-type devices and fastest P-type devices (SNFP); and

4) the CMOS circuit with slowest N-type devices and slowest P-type devices (SNSP).

Thus, for the design of a CMOS circuit, there can be four sigma values associated with each process dependent model parameter, i.e., an FNFP sigma value, an FNSP sigma value, an SNFP sigma value, and an SNSP sigma value. Each of the four sigma values for a process dependent model parameter corresponds to one of four corner values for the process dependent model parameter, which is included in a corresponding one of the four corner models.

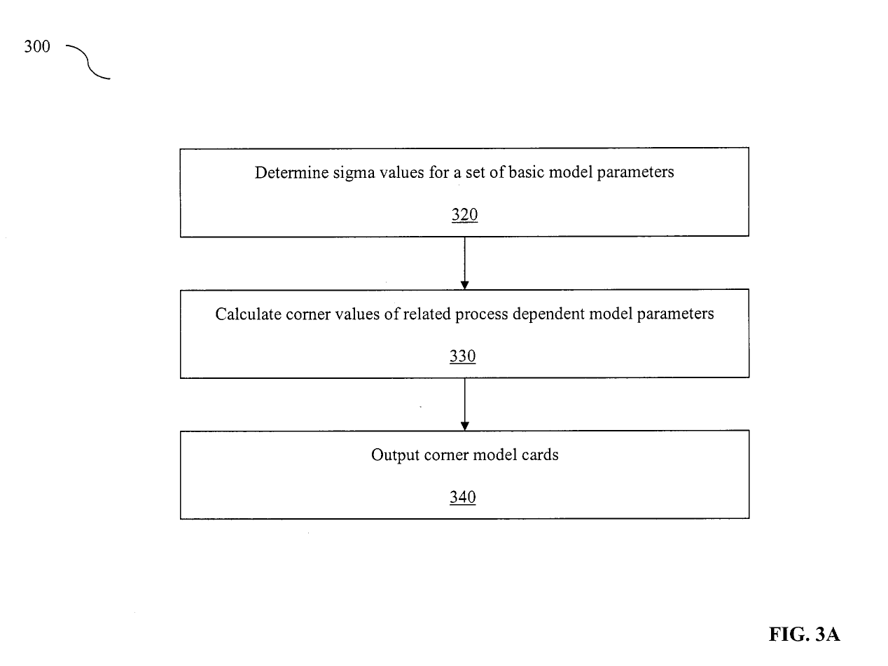

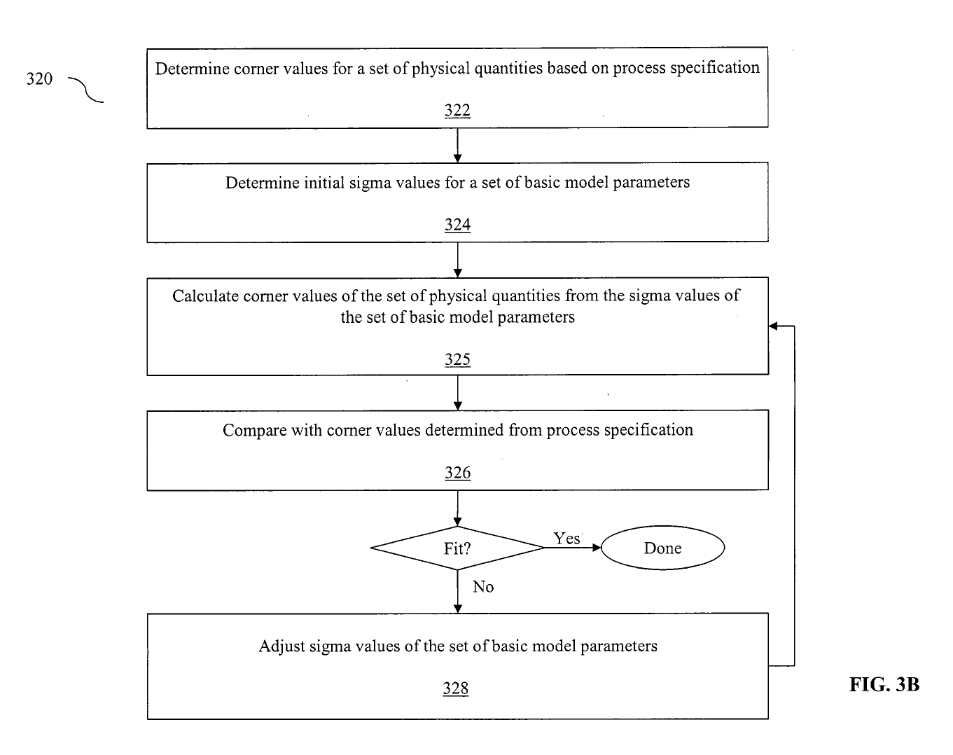

Referring now to FIG. 3A, according to one embodiment of the present invention, a process 300 for generating each one of the above initial corner models, such as the FNFP corner model, includes step 320 in which FNFP sigma values for a set of basic process parameters are determined, step 330 in which corner values of process dependent model parameters that are related to the set of basic process parameters are calculated, and step 340 in which the corner model card is output. The selection of the set of basic process parameters depends on the type of semiconductor device being modeled and the model used to model the device. For example, when the BSIM3 model is used to model MOSFET devices, the set of basic process parameters includes Tox, Nch, Wint, Lint and Vfb. In one embodiment of the present invention, as illustrated in FIG. 3B, step 320 for determining the FNFP sigma values of the basic process parameters includes substep 322 in which FNFP corner values of a set of physical quantities (targets) are determined. The selection of the targets also depends on the type of semiconductor device being modeled and the type of model used to model the device. For example, when the BSIM3 model is used to model MOSFET devices, the targets include Vth, Idsat, etc. The FNFP corner values of the targets can be determined from the standard deviation values of the targets given in the process specification to reflect expected process variation.

Upon determination of the FNFP corner values of the targets, the FNFP sigma values of the set of basic process parameters can be determined using a calibrated Monte Carlo method. As shown in FIG. 3B, step 320 for determining the FNFP sigma values of the basic process parameters further includes substep 324 in which initial FNFP sigma values for the set of basic process parameters are determined based on a best guess of these values or a corresponding corner model card associated with the previous IC technology. The initial FNFP sigma values of the set of basic process parameters are then used to calculate the FNFP corner values of the set of basic process parameters. The calculated FNFP corner values of the set of basic process parameters are in turn used to calculate in substep 325 the FNFP corner values of the targets, using model equations and/or device physics knowledge known to those skilled in the art. The calculated FNFP corner values of the targets are compared in substep 326 with the corner values of the targets determined from process specification. If the differences are beyond preset acceptable limits, the FNFP sigma values of the set of basic process parameters are adjusted accordingly in substep 328, and the FNFP corner values of the targets are recalculated in substep 325 based on the adjusted FNFP sigma values of the set of basic process parameters. This process repeats until the differences between the FNFP corner values of the targets calculated from the FNFP sigma values of the set of basic process parameters and the FNFP corner values of the target determined from the process specification are within the acceptable limits.

Referring back to FIG. 3A, the FNFP sigma values of the set of basic process parameters determined in step 320 can be used to calculate in step 330 FNFP corner values of process dependent model parameters that are related to the set of basic process parameters. The relationship of the related process dependent model parameters with the set of basic process parameters can usually be expressed in mathematical equations derived using model equations and/or device physics knowledge known to those skilled in the art. For example, when BSIM3 model is used to model MOSFET devices, the set of basic parameters are Tox, Nch, Wint, Lint and Vfb, and the related process dependent model parameters are Vth0, K1, Cgso, Cgdo . . . etc. As an example, K1 can be expressed as:

$$K1 = Typical\_value * ( 1 + \frac{Tox\_sga}{Tox} ) \sqrt{1 + Nch\_sga}$$

where Typical_Value is the typical value of K1 taken from the initial typical model card generated, e.g., by process 200, Tox_sga and Nch_sga are the FNFP sigma values of Tox and Nch, respectively, and Tox is the typical value of Tox also taken from the initial typical model card. A list of some of the other equations for calculating corner values of process dependent model parameters can be found in Appendix I. The FNFP corner values of the basic process parameters and the corner values of the related process dependent model parameters, together with the typical values of the other model parameters, are output in step 340 as the initial FNFP corner model card.

The initial typical and corner models generated based on the process specification using the methods discussed above can be used by circuit designer to come up with an initial design of a circuit. This design may not be accurate because the initial typical and corner models do not reflect actual process fluctuations. Therefore, more accurate typical model and corner models may be required after the fabrication process is developed and actual data from fabricated devices or test structures are available for model generation.

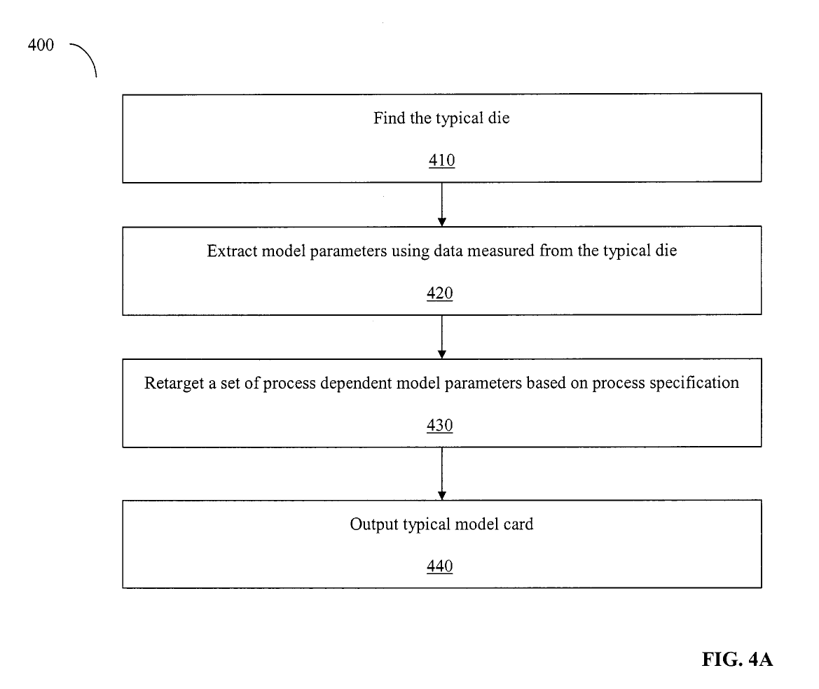

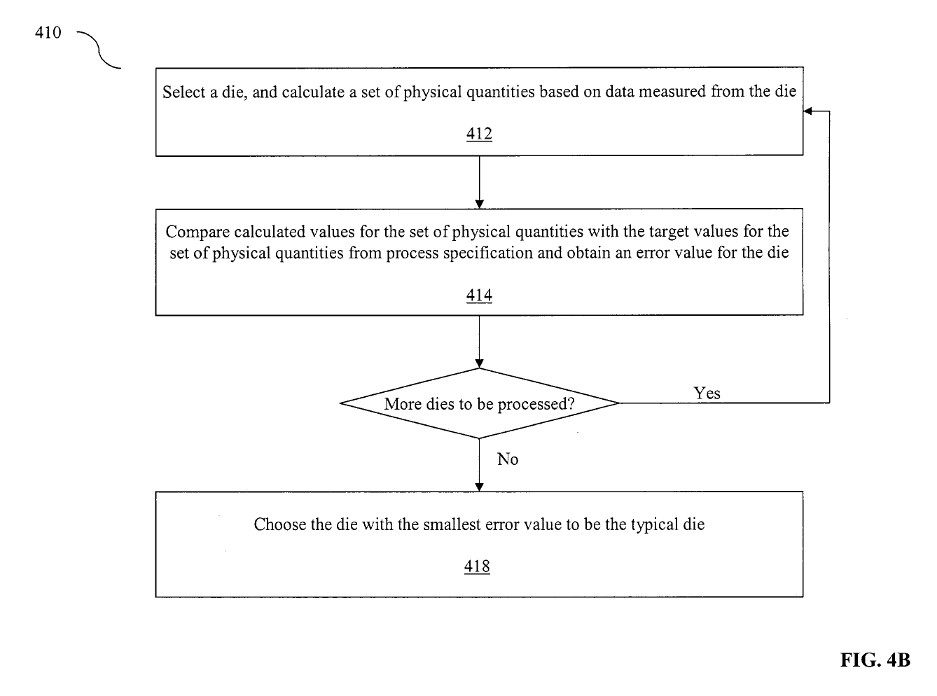

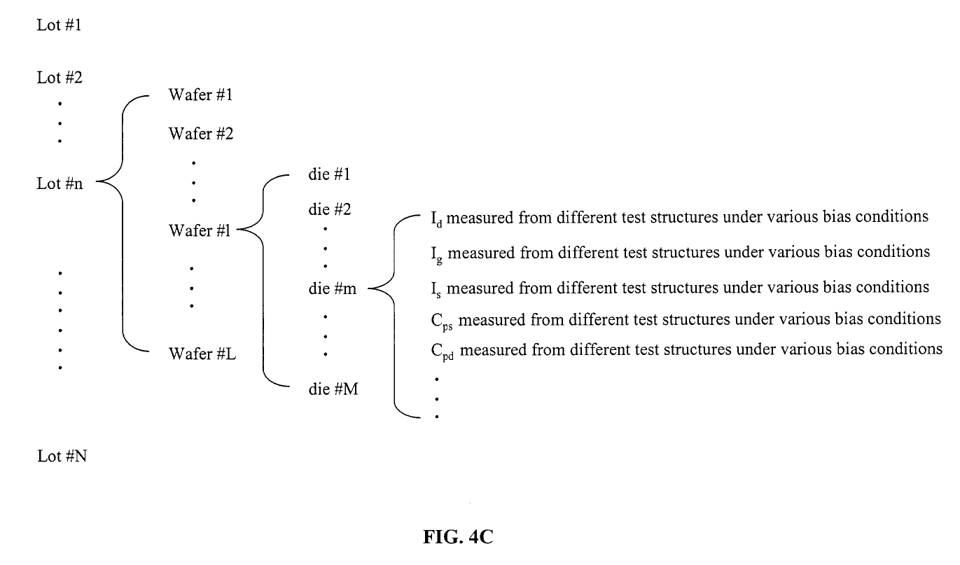

Referring now to FIG. 4A, according to one embodiment of the present invention, a process 400 for generating a typical model card using measured data includes step 410 in which a typical die is selected out of a plurality of dies on which the data are measured. A die is a piece of a semiconductor wafer on which integrated circuit devices are fabricated. The plurality of dies are preferably taken from different wafers that has come out of different process runs (lots). As illustrated in FIG. 4C, the different lots include lot #1, lot #2, . . . , lot #n, . . . , and lot #N, where n and N are positive integers. From each lot, such as lot #n, one or more wafers, such as wafer #1, wafer #2, etc., were taken for measurement. On each wafer, one or more dies, such as die #1, die #2, etc., at different locations are selected for measurement. In one embodiment of the present invention, the measured data includes terminal current and/or capacitance data measured using various test devices under different bias conditions in each of the plurality of dies.

Process 400 further includes step 420 in which model parameters are extracted based on data measured using the typical die, step 430 in which a set of process dependent process parameters are selected among the model parameters for retargeting based on the process specification, and step 440 in which the typical model card is formed and output. As illustrated in FIG. 4B, in one embodiment of the present invention, step 410 for finding a typical die among the plurality of dies includes substep 412 in which values of a set of physical quantities (targets) are calculated for each die based on data measured from the die, substep 414 in which calculated values of the targets for each die are compared with specified values of the targets in the process specification to obtain an error value, and step 418 in which the die with the smallest error value is selected as the typical die. The selection of the targets depends on the type of semiconductor device being modeled and the type of model used to model the device. For example, when the BSIM3 model is used to model MOSFET devices, the targets typically include Vth, Idsat, etc.

In one embodiment of the present invention, to calculate the values of the targets in substep 412, model parameters are extracted for each die using the data measured on the die, and the extracted model parameters are used to calculate the values of the targets for the die. The selection of a method for model parameter extraction depends on the model used and the device being modeled. Also, for a specific model and a specific type of device, different model extraction method can be used. A method for extracting BSIM3 model parameters is discussed by Daniel P. Foty, “Modeling with SPICE—Principles and Practice,” published by Prentice Hall PTR, 1997, which is incorporated herein by reference in its entirety. The extraction may also be done using BSIMPro+™. Relevant model equations and/or device physics knowledge known to those skilled in the art may be used to calculate the values of the targets from the extracted model parameters. The calculated values of the targets are then compared in substep 414 with the typical values of the targets specified in the process specification. In one embodiment of the present invention, the comparison results in an error value associated with each of the plurality of dies. The error value should reflect an overall difference between calculated values and specified values of the targets. For example, the error value can be the square root of the sum of the square of the difference between the calculated and specified values of each target:

$$error = \sqrt{\frac{{\sum }_{i} {( {T}_{i} \_calculated - {T}_{i} \_specified )}^{2}}{{T}_{i} {\_specified}^{2}}}$$

where T_{i—}calculated and T_{i—}specified represent the calculated and specified values of the i^{th} target, respectively. The die with the smallest error value is chosen in substep 418 to be the typical die.

Once the typical die is found, model parameters extracted using data measured from the typical die are used to generate the typical model. Because the amount of dies used for data measurement are usually limited by time and resources available, the typical die found among the plurality of dies may not accurately reflect the typical situations specified in the process specification. Therefore, retargeting in step 430 of a selected set of process dependent model parameters may be needed, and is performed using a method similar to that used in step 230 as discussed above in association with FIG. 2B. The retargeted process dependent model parameters are output in step 440 together with the rest of the extracted parameters from the typical die as the typical model card.

The corner models may also be generated based on measured data. In one embodiment of the present invention, for the design of a CMOS circuit, the corner models typically includes four different types of corner models, each corresponding to one of the following situations:

1) the CMOS circuit with fastest N-type devices and fastest P-type devices (FNFP);

2) the CMOS circuit with fastest N-type devices and slowest P-type devices (FNSP);

3) the CMOS circuit with slowest N-type devices and fastest P-type devices (SNFP); and

4) the CMOS circuit with slowest N-type devices and slowest P-type devices (SNSP).

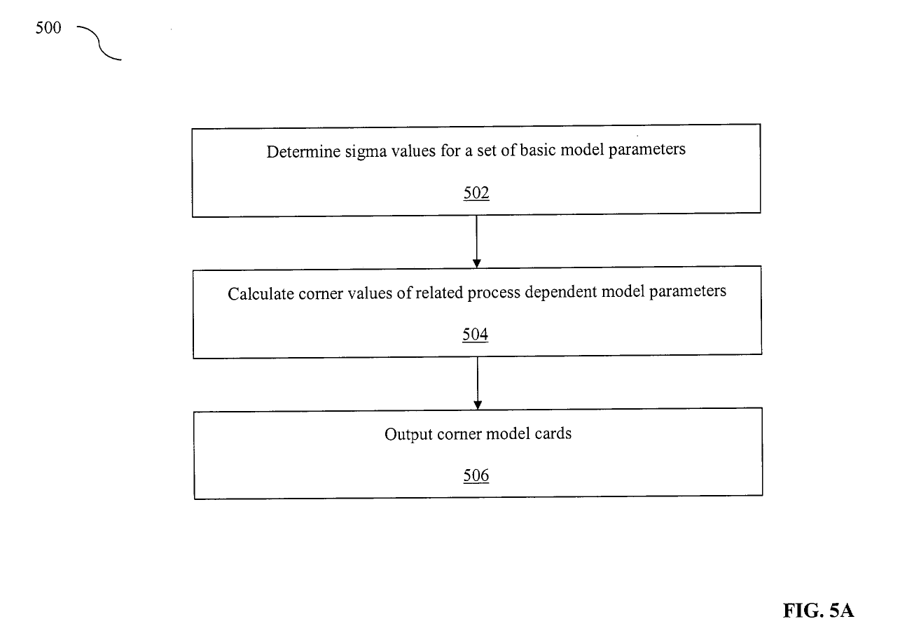

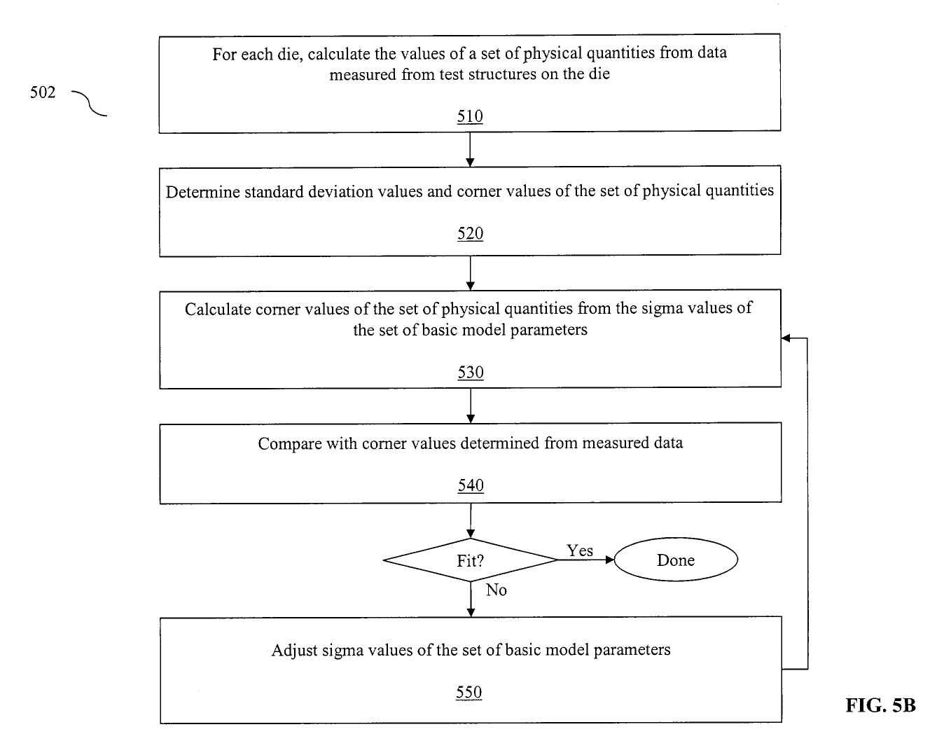

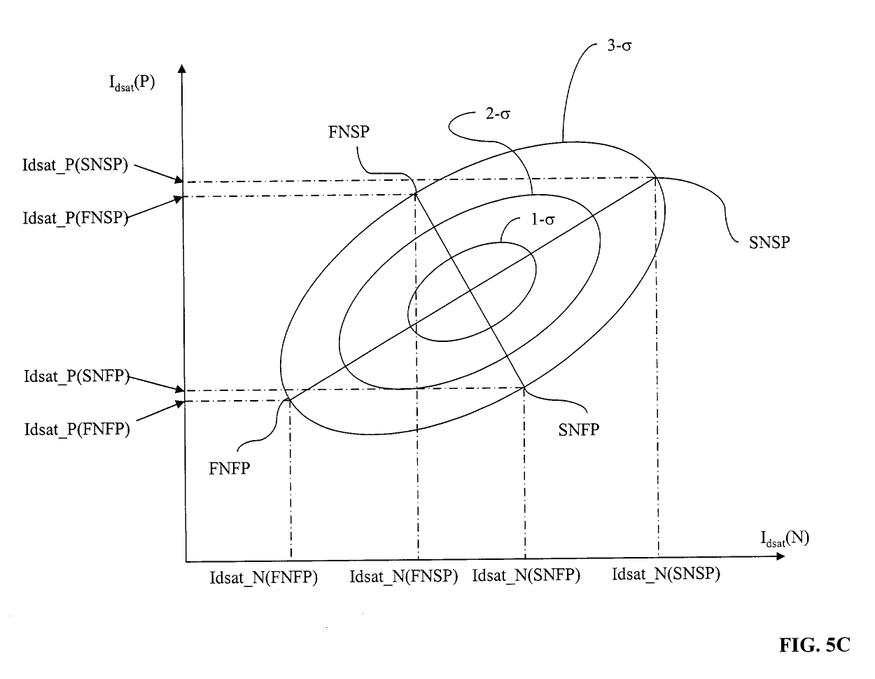

In one embodiment of the present invention, as shown in FIG. 5A, a process 500 for generating each of the above corner models based on measured data includes determining in step 502 the corresponding sigma values for a set of basic process parameters, calculating in step 504 corner values for other process dependent model parameters that are related to the set of basic process parameters, and outputting in step 506 the corner model cards. Again, the selection of the set of basic process parameters depends on the type of semiconductor device being modeled and the model used to model the device. For example, when the BSIM3 model is used to model MOSFET devices, the set of basic process parameters includes Tox, Nch, Wint, Lint and Vfb.

As shown in FIG. 5B, step 502 for determining the corresponding sigma values of a set of basic process parameters based on measured data includes step 510 in which the values of a set of physical quantities (targets) are calculated for each die based on data measured from test structures on the die, step 520 in which standard deviation values and corner values of the targets are determined, step 530 in which corner values of the targets are calculated based on an initial guess of the sigma values of the set of basic model parameters, step 540 in which corner values of the targets determined in step 520 and calculated in step 530 are compared, and step 550 in which the sigma values of the set of basic model parameters are adjusted based on results of the comparison in step 540. Steps 530 through 540 are iterated until the comparison in step 540 yields satisfactory results.

In one embodiment of the present invention, in step 510, calculating the values of the targets based on data measured from test structures on each die may include extracting model parameters using data measured on the die, and calculating the values of the targets from the extracted model parameters. Relevant model equations and/or device physics knowledge known to those skilled in the art may be used to calculate the values of the targets from the extracted model parameters. The targets are selected based on the type of semiconductor device being modeled and the type of model used to model the device. For example, when the BSIM3 model is used to model MOSFET devices in CMOS circuits, the targets typically include Vth, Idsat, etc., for both P-type and N-type devices.

Once the values of the targets corresponding to each die are calculated, process 500 proceeds to determine in step 520 the standard deviation values and corner values for each target based on the distribution of the target across the plurality of dies. The standard deviation of each target can be calculated using conventional statistical method for calculating standard deviations. Calculation of the corner values is more complicated when some of the targets correlate with each other. For example, for the design of a CMOS circuit, the drain saturation current for P-type devices (Idsat-P) and the drain saturation current for N-type devices (Idsat_N) are usually correlated. The correlation can be shown by treating Idsat_N and Idsat_P from each die as an (x,y) point in an x-y plot. The (Idsat_N, Idsat_P) points of all the dies are usually found to form an elliptic shape, as illustrated in FIG. 5C. The center of the elliptic shape corresponds to the Idsat_N and Idsat_P values from the typical die, and curves outlining the elliptic shape are deviations from the typical die. FIG. 5C shows 3 outlining ellipses corresponding to 1×sigma (1−σ) deviation, 2×sigma (2−σ) deviation, and 3×sigma (3−σ) deviation, respectively, from the Idsat_N and Idsat_P values for the typical die. In one embodiment of the present invention, the 3−σ ellipse is used to determine the corner values, Idsat_N(FNFP), Idsat_N(FNSP), Idsat_N(SNFP), Idsat_N(SNSP), Idsat_P(FNFP), Idsat_P(FNSP), Idsat_P(SNFP), and Idsat_P(SNSP), as illustrated in FIG. 5C.

Upon determination of the corner values of the targets, the corresponding sigma values of the set of basic process parameters can be determined using a calibrated Monte Carlo method. In one embodiment of the present invention, as shown in FIG. 5A, the calibrated Monte Carlo method comprises calculating in step 530 corner values of the targets based on the corresponding sigma values of the set of basic process parameters. The corresponding sigma vales for the set of basic process parameters can initially be determined based on a best guess of these values or can be taken from the initial corner models determined using the methods discussed above in association with FIG. 3A and FIG. 3B. The calculated corner values of the targets are then compared in step 540 with the corresponding corner values of the targets determined from measured data. If the differences are beyond preset acceptable limits, the corresponding sigma values of the set of basic process parameters are adjusted accordingly in step 550, and the corner values of the targets are recalculated in step 530 using the adjusted sigma values of the set of basic process parameters. This process repeats until the differences between the corner values of the targets calculated from the corresponding sigma values of the set of basic process parameters and corresponding the corner values of the target determined from the measured data are within the acceptable limits.

The sigma values of the set of basic process parameters determined using the calibrated MC method are used to calculate the corresponding corner values of other process dependent model parameters that are related to the set of basic process parameters. The relationship of the related process dependent model parameters with the set of basic process parameters can usually be expressed in mathematical equations derived using model equations and/or device physics knowledge known to those skilled in the art. For example, when BSIM3 model is used to model MOSFET devices, the set of basic process parameters are Tox, Nch, Wint, Lint and Vfb, and the related process dependent model parameters are Vth0, K1, Cgso, Cgdo . . . etc., and, as an example, when FNFP corner model card is being calculated, K1 can be expressed as:

$$K1 = Typical\_value * ( 1 + \frac{Tox\_sga}{Tox} ) \sqrt{1 + Nch\_sga}$$

where Typical_Value is the typical value of KI taken from the initial typical model card produced, e.g., by process 200, Tox_sga and Nch_sga are the FNFP sigma values of Tox and Nch, respectively, and Tox is the typical value of Tox also taken from the initial typical model card. Some of the other equations for calculating process dependent parameters can be found in Appendix I. The FNFP corner values of the basic process parameters and the related process dependent model parameters, together with the typical values of the other model parameters, are included in the FNFP corner model card.

The exact order of some of the steps in the methods described above can be altered. In addition, steps may be added or omitted and varied depending upon the requirements of a particular modeling application and the circuit simulator that will use the models generated. The above method steps and the order in which they are presented are chosen for illustrative purposes and to provide a picture of a complete process sequence.

[image]

What is claimed is:

1. A method for determining model parameters in a semiconductor device model, comprising:
obtaining model information associated with a previous semiconductor device fabrication process;
calculating values of a set of physical quantities based on the model information; and
retargeting values of a set of model parameters selected from the model information so that the calculated values of the set of physical quantities fit specified values of the set of physical quantities in a process specification.

2. The method of claim 1, wherein retargeting the values of the set of model parameters comprises:
obtaining differences between calculated values of the set of physical quantities and the specified values of the set of physical quantities in the process specification; and
adjusting the values of the set of model parameters in response to the differences exceeding preset acceptable limits.

3. The method of claim 2, further comprising recalculating the values of the set of physical quantities based on the adjusted values of the set of model parameters.

4. A method for determining model parameters of a semiconductor device model using data measured on a plurality of semiconductor dies, comprising:
finding a typical die among the plurality of semiconductor dies based on data measured on the plurality of semiconductor dies; and
retargeting a plurality model parameters extracted based on data measured on the typical die so values of a set of physical quantities calculated using the plurality of model parameters fit specified values of the set of physical quantities in a process specification.

5. The method of claim 4, wherein the plurality of dies are taken from a plurality of semiconductor wafers processed in different process runs.

6. The method of claim 4, wherein finding a typical die further comprises:
for each die, calculating the values of the set of physical quantities using data measured on the die;
for each die, obtaining an error value reflecting the difference between calculated values of the set of physical quantities and the specified values of the physical quantities in the process specification; and
selecting the die with the smallest error value to be the typical die.

7. The method of claim 6, wherein calculating the values of the set of physical quantities for each die using data measured on the die further comprises:
extracting model parameters based data measured on the die; and
calculating the values of the set of physical quantities using the extracted model parameters.

8. The method of claim 4, wherein retargeting the values of the set of model parameters comprises:
obtaining differences between values of the set of physical quantities calculated using the plurality of model parameters and the specified values of the set of physical quantities in the process specification; and
in response to the differences exceeding preset acceptable limits, adjusting the values of the plurality of model parameters.

9. The method of claim 8, wherein retargeting further comprises:
recalculating the values of the set of physical quantities based on the adjusted values of the plurality of model parameters.

10. A method for determining corner values of model parameters in a semiconductor device model to account for possible deviations from typical device performance, the typical device performance being modeled by a typical device model including typical values of the model parameters, the method comprising:
determining sigma values of a set of basic process parameters selected from the model parameters in the device model;
calculating corner values of the set of basic process parameters using the typical values and the sigma values of the set of basic process parameters; and
calculating corner values of other model parameters that are related to the set of basic process parameters using the typical values of relevant model parameters in the typical device model and sigma values of the set of basic process parameters.

11. The method of claim 10, wherein determining sigma values of the set of basic process parameters comprises:
determining corner values of a set of physical quantities based on typical values and standard deviation values of the set of physical quantities specified in a process specification;
determining initial sigma values for the set of basic process parameters;
calculating corner values of the set of physical quantities using the initial sigma values for the set of basic process parameters; and
in response to the differences between calculated values for the set of physical quantities and the values of the set of physical quantities determined from the process specification exceeding preset acceptable limits, adjusting the sigma values of the set of basic process parameters.

12. The method of claim 11, further comprising:
recalculating the corner values of the set of physical quantities based on the adjusted sigma values of the set of basic process parameters.

13. The method of claim 10, wherein determining sigma values of the set of basic process parameters comprises:
obtaining data measured on a plurality of semiconductor dies;
for each die, calculating values of a set of physical quantities using data measured on the die;
determining corner values for the set of physical quantities based on distributions of the values of the set of physical quantities calculated using data measured on the plurality of dies;
calculating corner values for the set of physical quantities using initial guesses of sigma values for the set of basic process parameters;
obtaining differences between the corner values of the set of physical quantities cdetermined using measured data and the corresponding corner values of the set of physical quantities calculated using the initial guesses of sigma values for the set of basic process parameters; and
adjusting the sigma values of the set of basic process parameters in response to the differences exceeding preset acceptable limits.

14. The method of claim 13, further comprising:
recalculating the corner values of the set of physical quantities based on the adjusted sigma values of the set of basic process parameters.

15. The method of claim 13, wherein the plurality of dies are taken from a plurality of wafers processed in different process runs.

16. The method of claim 13, wherein calculating the values of the set of physical quantities for each die using data measured on the die further comprises:
extracting model parameters using data measured on the die; and
calculating the values of the set of physical quantities using the extracted model parameters.

17. A computer readable medium including computer readable program codes that when executed cause a computer to perform a method for determining model parameters in a semiconductor device model, comprising:
obtaining values of a set of physical quantities from a process specification associated with a current semiconductor device fabrication process;
obtaining model information associated with a previous semiconductor device fabrication process; and
retargeting values of a set of model parameters selected from the model information to fit the values of the set of physical quantities.

18. A computer readable medium including computer readable program codes that when executed cause a computer to perform a method for determining model parameters of a semiconductor device model using data measured on a plurality of semiconductor dies, comprising:
obtaining values of a set of physical quantities from a process specification associated with a process for fabricating the plurality of semiconductor dies;
finding a typical die among the plurality of semiconductor dies based on data measured on the plurality of semiconductor dies; and
retargeting values of a set of model parameters extracted using data measured from the typical die to fit the values of the set of physical quantities.

19. A computer readable medium including computer readable program codes that when executed cause a computer to perform a method for determining corner values of model parameters in a semiconductor device model to account for possible deviations from typical device performance, the typical device performance being modeled by a typical device model including typical values of the model parameters, the method comprising:
determining sigma values of a set of basic process parameters selected from the model parameters in the device model;
calculating corner values of the set of basic process parameters using the typical values and the sigma values of the set of basic process parameters; and
calculating corner values of other model parameters that are related to the set of basic process parameters using the typical values of relevant model parameters in the typical device model and sigma values of the set of basic process parameters.

20. The computer readable medium of claim 19, wherein determining sigma values of the set of basic process parameters comprises:
determining corner values of a set of physical quantities based on typical values and standard deviation values of the set of physical quantities specified in a process specification;
determining initial sigma values for the set of basic process parameters;
calculating corner values of the set of physical quantities using the initial sigma values for the set of basic process parameters; and
in response to the differences between calculated values for the set of physical quantities and the values of the set of physical quantities determined from the process specification exceeding preset acceptable limits, adjusting the sigma values of the set of basic process parameters.

21. The computer readable medium of claim 19, wherein determining sigma values of the set of basic process parameters comprises:
obtaining data measured on a plurality of semiconductor dies;
for each die, calculating values of a set of physical quantities using data measured on the die;
determining corner values for the set of physical quantities based on distributions of the values of the set of physical quantities calculated using data measured on the plurality of dies;
calculating corner values for the set of physical quantities using initial guesses of sigma values for the set of basic process parameters;
obtaining differences between the corner values of the set of physical quantities cdetermined using measured data and the corresponding corner values of the set of physical quantities calculated using the initial guesses of sigma values for the set of basic process parameters; and
adjusting the sigma values of the set of basic process parameters in response to the differences exceeding preset acceptable limits.
